(19) United States
(12) Patent Application Publication
(10) Pub. No.: US 2026/0013470 A1
(43) Pub. Date: Jan. 15, 2026

(54) Height Adjustable Pet Bathtub

(71) Applicant: Yajun Hu, Palos Verdes Estates, CA (US)

(72) Inventor: Yajun Hu, Palos Verdes Estates, CA (US)

(73) Assignee: Eureka LLC, Palos Verdes Estates, CA (US)

(21) Appl. No.: 19/313,276

(22) Filed: Aug. 28, 2025

(30) Foreign Application Priority Data
Jul. 9, 2024 (CN) 202421623430.4

(51) Int. Cl. A01K 13/00

(52) U.S. Cl. CPC A01K 13/001

(57) ABSTRACT

A height adjustable pet bathtub is provided. The bathtub comprises a bathtub body, a work platform, and a lifting mechanism. The bathtub body defines a rinsing space, the work platform is positioned within the rinsing space, and the lifting mechanism is disposed in a wall of the bathtub body and connected to the work platform to move the work platform up and down. The invention allows for convenient cleaning of pets of different sizes, improving versatility and practicality.

### CROSS-REFERENCE TO RELATED APPLICATIONS

This application claims priority to Chinese Patent Application No. [202421623430.4], filed on Jul. 9, 2024, the disclosure of which is incorporated herein by reference in its entirety.

### FIELD OF THE INVENTION

The present invention relates to the field of bathtubs, and more particularly to a height adjustable bathtub designed for pets.

### BACKGROUND OF THE INVENTION

The rapid growth of the pet market has created demand for high-end pet care products. Pet bathtubs are commonly used in pet grooming shops for cleaning and bathing pets, providing hygiene benefits and convenience.

However, existing pet bathtubs suffer from limitations. Most pets dislike immersion in water, so pet grooming shops typically use rinse-based bathing. Current pet bathtubs are fixed in height, making them inconvenient. If the bathtub height is too low, water splashes out easily, complicating cleanup. If the bathtub height is too high, operators must bend excessively, causing discomfort and increased labor intensity. Thus, existing pet bathtubs have poor versatility and limited practicality.

### SUMMARY OF THE INVENTION

The present invention aims to overcome the drawbacks of the prior art by providing a height adjustable pet bathtub adaptable for cleaning pets of different sizes. The invention improves versatility, usability, and convenience in pet grooming.

In one aspect, a height adjustable pet bathtub is provided, comprising:
a bathtub body having a rinsing space;
a work platform disposed within the rinsing space; and
a lifting mechanism disposed inside a wall of the bathtub body and connected to the work platform, configured to drive the work platform up and down within the rinsing space.

### BRIEF DESCRIPTION OF THE DRAWINGS

FIG. 1 is a schematic view of the height adjustable pet bathtub.

FIG. 2 is an exploded view of the height adjustable pet bathtub.

FIG. 3 is a schematic view of the height adjustable pet bathtub with the work platform raised (detachable baffle not shown).

Reference numerals: 1 bathtub body; 2 work platform; 2.1 bottom plate; 2.2 side plate; 2.3 mounting plate; 3 electric push rod; 4 anti-slip pad; 5 door; 6 lock; 7 faucet; 8 faucet switch; 9 hanging ring; 10 baffle; 11 drain valve switch.

### DETAILED DESCRIPTION OF THE INVENTION

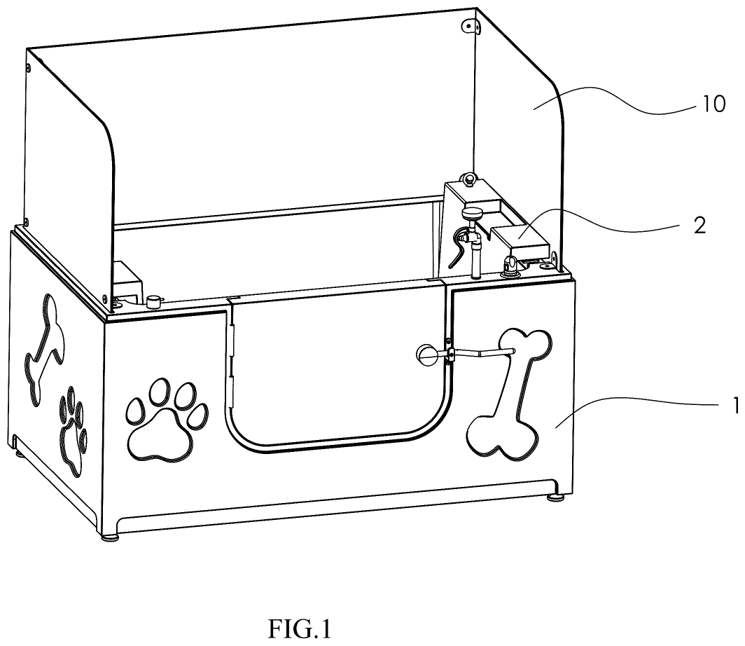

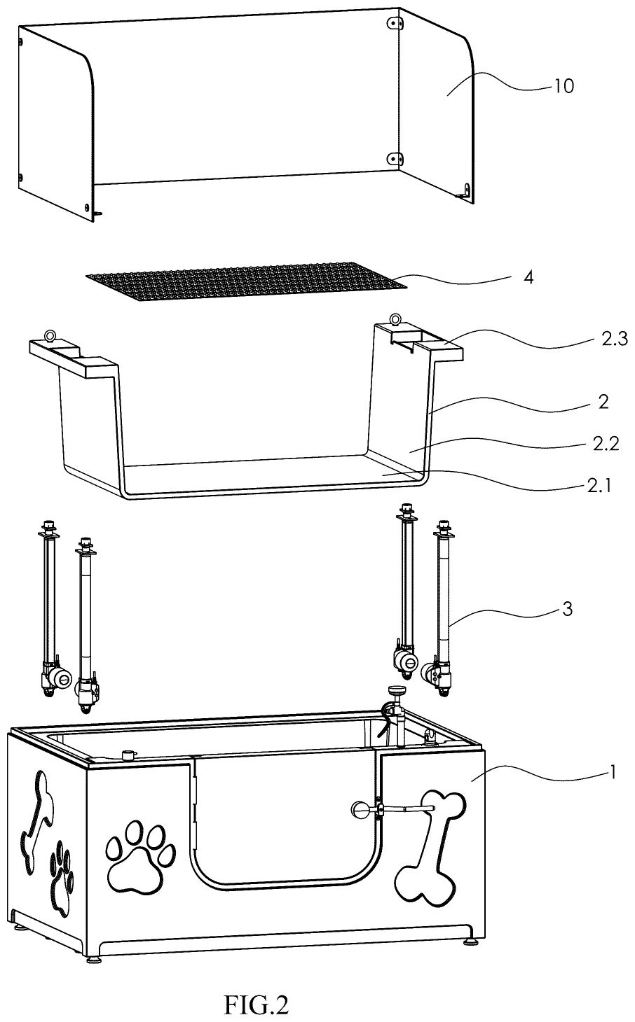

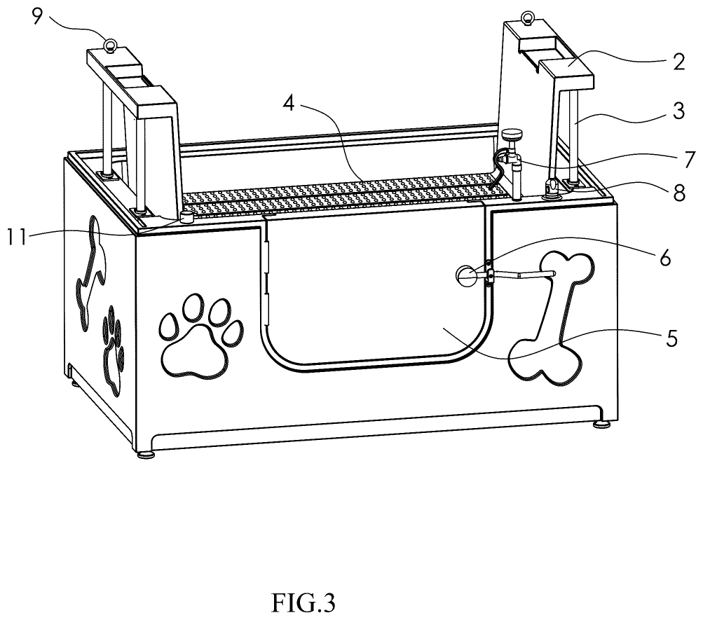

Referring to FIGS. 1-3, the height adjustable pet bathtub comprises a bathtub body (1), a work platform (2), and a plurality of electric push rods (3). The bathtub body (1) defines a rinsing space, and the work platform (2) is positioned within the rinsing space. The push rods (3) are mounted within walls of the bathtub body (1) and are connected to the work platform (2), thereby driving the work platform up and down.

The push rods (3) may be commercially available electric actuators, operable via a handheld or foot-operated remote controller. The work platform (2) includes a bottom plate (2.1) and side plates (2.2). A mounting plate (2.3) extends outward from an upper end of the side plates (2.2) and connects perpendicularly to the side plates (2.2). The push rods (3) engage with the mounting plate (2.3), thereby lifting the work platform (2).

An anti-slip pad (4) is provided on the surface of the bottom plate (2.1). The bathtub body (1) includes a notch for pet entry, the notch being equipped with a hinged door (5) and a lock (6). A sealing strip is provided between the door (5) and the bathtub wall to prevent leakage.

The bathtub wall further includes a faucet (7) and a faucet switch (8). The faucet (7) may be connected to an external shower head. The work platform (2) includes a hanging ring (9) for securing a pet leash. One side of the bathtub serves as an operator station, while the remaining edges are surrounded by detachable baffles (10) to prevent splashing.

A drain port is provided at the bottom of the bathtub body (1), with a drain valve connected to a drain valve switch (11) mounted on the bathtub wall.

Through operation of the push rods (3), the height of the work platform (2) can be conveniently adjusted, enabling ergonomic pet cleaning for pets of varying sizes. The fixed height of the bathtub body (1) avoids obstructing the operator's work.

It will be understood that the foregoing embodiments are illustrative and not limiting. Modifications, substitutions, and equivalents within the spirit and scope of the invention are intended to be covered.

1. A height adjustable pet bathtub comprising: a bathtub body defining a rinsing space; a work platform positioned within the rinsing space; and a lifting mechanism disposed in a wall of the bathtub body and connected to the work platform, the lifting mechanism being configured to drive the work platform to move up and down within the rinsing space.

2. The height adjustable pet bathtub of claim 1, wherein the lifting mechanism comprises a plurality of electric push rods fixed inside the bathtub wall, each push rod having a drive portion connected to the work platform.

3. The height adjustable pet bathtub of claim 1, wherein the work platform comprises a bottom plate and side plates, the side plates being connected to the bottom plate, and an upper end of the side plates being provided with a mounting plate connected to the lifting mechanism.

4. The height adjustable pet bathtub of claim 3, wherein the mounting plate extends outward from the side plates and is perpendicular thereto.

5. The height adjustable pet bathtub of claim 3, wherein the bottom plate is provided with an anti-slip pad.

6. The height adjustable pet bathtub of claim 1, wherein the bathtub body includes a notch for pet entry, and the notch is provided with a hinged door and a lock, the door being lockable to the bathtub wall, and a sealing strip being disposed between the door and the bathtub wall.

7. The height adjustable pet bathtub of claim 1, wherein the bathtub wall is provided with a faucet and a faucet switch, the faucet being connectable to an external shower head.

8. The height adjustable pet bathtub of claim 1, wherein the work platform is provided with a hanging ring for securing a pet leash.

9. The height adjustable pet bathtub of claim 1, wherein one side of the bathtub body serves as an operator station, and detachable baffles are provided along remaining sides of the bathtub body.

10. The height adjustable pet bathtub of claim 1, wherein the bathtub body has a drain port at a bottom thereof, the drain port being provided with a drain valve, and the bathtub wall being provided with a drain valve switch connected to the drain valve.
